(19) United States
(12) Patent Application Publication
(10) Pub. No.: US 2016/0289057 A1
(43) Pub. Date: Oct. 6, 2016

(54) Fork Lift Attachment Clip Wear Indicator

(71) Applicant: Arrow Acquisition, LLC, Lenexa, KS (US)

(72) Inventors: Terrence S. Melvin, Lenexa, KS (US); Ross T. Gault, Lenexa, KS (US)

(21) Appl. No.: 14/673,212

(22) Filed: Mar. 30, 2015

(51) Int. Cl. B66F 17/00; B66F 9/12

(52) U.S. Cl. CPC B66F 17/003; B66F 9/12

(57) ABSTRACT

A clip for a fork lift attachment that includes a clip wear indicator that provides a visible indication of wear.

This invention pertains to a clip for a fork lift attachment that includes a clip wear indicator that provides a visible indication of wear.

### BRIEF DESCRIPTION OF THE DRAWINGS

The following drawings illustrate the concepts of the present invention, and are not necessarily drawn to scale.

FIG. 1 is a right side view of an embodiment of a fork lift attachment with two clips.

FIG. 2 is an enlarged left side view of an embodiment of a clip.

FIG. 3 is an enlarged right side view of the embodiment of FIG. 2.

FIG. 4 is a rear perspective view of the embodiment of FIG. 2.

### DETAILED DESCRIPTION OF SOME EMBODIMENTS

While the present invention is susceptible of embodiment in various forms, there is shown in the drawings and will hereinafter be described some embodiments with the understanding that the present disclosure is to be considered an exemplification of the invention and is not intended to limit the invention to the specific embodiments illustrated or described.

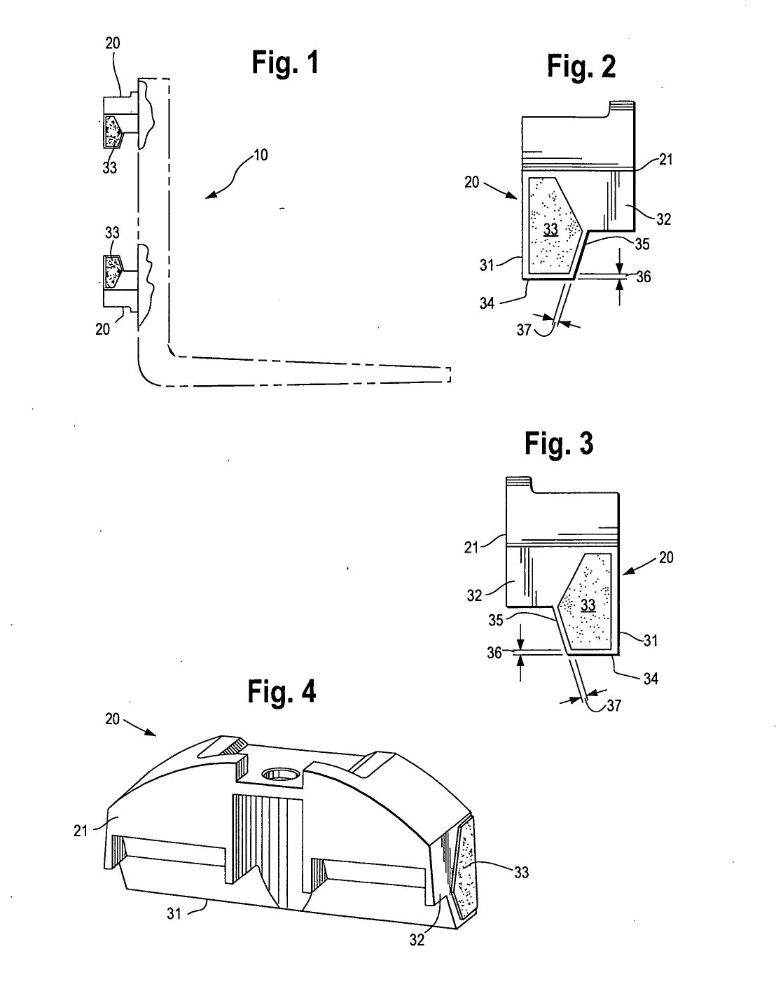

There are a variety of fork lift attachments that are intended to be attached to a fork lift carriage. The largest part of a fork lift attachment is a load-engaging portion that engages a load being moved, but a fork lift attachment typically also includes clips are used to at least temporarily mount the fork lift attachment on a fork lift carriage. FIG. 1 illustrates one embodiment of a fork lift attachment 10 that includes two clips 20. FIGS. 2-4 illustrate left, right, and rear perspective views of an embodiment of a clip 20. A pair of forks such as shown in FIG. 1 that is attached to a fork lift carriage for lifting pallets, for example, may be the most common fork lift attachment. Other common fork lift attachments that use clips as illustrated in the drawings include, for example, a rug pole attachment, a lifting boom, a trailer spotter attachment, a sideshifter (that allows an operator to move the forks laterally), a rotator (that allows the forks to be rotated), a fork positioner (that allows the forks to be moved together or apart), a roll and barrel attachment, a carton and multipurpose clamp attachment, a push-pull slip sheet attachment, telescopic forks, scales, and single-double forks.

The illustrated clip 20 includes a base portion 21 and an extension portion 31. The base portion 21 is designed to adjoin the clip 20 to a load-engaging portion of a fork lift attachment 10. For example, the base portion 21 may be permanently welded to a load-engaging portion of a fork lift attachment 10.

The extension portion 31 may be integral with the base portion 21, but is not in direct physical contact with a load-engaging portion of the fork lift attachment 10 even when the base portion 21 adjoins or is secured to the load-engaging portion of the fork lift attachment 10.

As illustrated in the figures, the extension portion 31 extends beyond the base portion 21 in a generally vertical direction. The extension portion 31 comprises an inside wear/bearing surface 35 that faces the load-engaging portion of the fork lift attachment 10 across a gap that is formed between the extension portion 31 and the load-engaging portion of the fork lift attachment 10. The extension portion 31 also comprises a generally horizontal peripheral wear/bearing surface 34 at a peripheral end of the extension portion 31. When a fork lift attachment 10 is mounted on a fork lift carriage, and especially when it is carrying a load, the peripheral and inside wear/bearing surfaces 34 and 35 are points of contact between the fork lift attachment 10 and the fork lift carriage. Those wear/bearing surfaces 34 and 35 are the most likely surfaces to get worn, and wearing of those surfaces can lead to diminished load bearing capacity and failure of the fork lift attachment 10.

The clip 20 comprises two opposing, generally vertical, side surfaces 32. The side surface 32 comprises a wear indicator 33 that is visually distinguishable from a remainder of the side surface 32. Wear indicator 33 provides an intuitive and quickly observed indication of the current performance and safety limitations of the fork lift attachment 10, resulting from clip wear caused by normal use and/or abuse.

Each of the side surfaces 32 meets the peripheral wear/bearing surface 34 at a peripheral edge, and meets the inside wear/bearing surface 35 at an inside edge. The wear indicator 33 is offset from the peripheral edge by a peripheral offset amount 36, and is offset from the inside edge by an inside offset amount 37. The peripheral offset amount 36 is an amount of wear of the peripheral wear/bearing surface 34 beyond which the clip 20 should no longer be used as a safety precaution, and the inside offset amount 37 is an amount of wear of the inside wear/bearing surface 35 beyond which the clip 20 should no longer be used as a safety precaution.

The wear indicator 33 may be, for example, stamped, painted or embossed in the side surface 32. It may be built into clip 20 as part of the same material as extension portion 31, or it may be of a different material. It may be a different color than the remainder of side surface 32.

As the offset amounts 36 and 37 get partially worn down, they are providing a visual indication of the remaining useful life of the clip 20. When wear extends through an offset amount 36 or 37 and into wear indicator 33, the clip 20 is fully worn and should be replaced. It is useful that some of wear indicator 33 is still visible in the fully worn condition, and that it is readily distinguishable from an offset amount 36 or 37 that may no longer be seen. The wear indicator 33 and the offset amounts 36 and 37 comprise a means for indicating when the clip is sufficiently worn that it should no longer be used for temporarily mounting the fork lift attachment 10 to the fork lift carriage.

From the foregoing, it will be understood that numerous modifications and variations can be effectuated without departing from the true spirit and scope of the novel concepts of the present invention. It is to be understood that no limitation with respect to the specific embodiments illustrated and described is intended or should be inferred.

What is claimed is:

1. A clip for a fork lift attachment, the clip being used for mounting the fork lift attachment on a fork lift carriage, the clip comprising:
a base portion and an extension portion;
wherein the base portion adjoins a load-engaging portion of the fork lift attachment or is structured and dimensioned for securing the clip to the load-engaging portion of the fork lift attachment;
wherein the extension portion is integral with the base portion but is not in direct physical contact with the load-engaging portion of the fork lift attachment even when the base portion adjoins or is secured to the load-engaging portion of the fork lift attachment;
wherein the extension portion extends beyond the base portion in a generally vertical direction, and comprises an inside wear/bearing surface that faces the load-engaging portion of the fork lift attachment across a gap that is formed between the extension portion and the load-engaging portion of the fork lift attachment when the base portion adjoins or is secured to the load-engaging portion of the fork lift attachment;
wherein the extension portion further comprises a generally horizontal peripheral wear/bearing surface at a peripheral end of the extension portion;
wherein the clip comprises two opposing, generally vertical, side surfaces, each of the two side surfaces meeting the peripheral wear/bearing surface at a respective peripheral edge, and each of the two side surfaces meeting the inside wear/bearing surface at a respective inside edge;
wherein at least one of the two side surfaces comprises a wear indicator, that is visually distinguishable from a remainder of the at least one side surface, that is offset from the respective peripheral edge of the at least one side surface by a peripheral offset amount, and that is offset from the respective inside edge of the at least one side surface by an inside offset amount;
wherein the peripheral offset amount is an amount of wear of the peripheral wear/bearing surface beyond which the clip should no longer be used as a safety precaution; and
wherein the inside offset amount is an amount of wear of the inside wear/bearing surface beyond which the clip should no longer be used as a safety precaution.

2. The clip as in claim 1, wherein the wear indicator is composed of the same material as a remainder of the extension portion.

3. The clip as in claim 1, wherein the wear indicator is composed of a different material than a remainder of the extension portion.

4. The clip as in claim 1, wherein the wear indicator is embossed on the at least one side surface.

5. The clip as in claim 1, wherein the wear indicator is stamped on the at least one side surface.

6. The clip as in claim 1, wherein the wear indicator is painted on the at least one side surface.

7. The clip as in claim 1, wherein a color of the wear indicator is different than a color of the remainder of the at least one side surface between the wear indicator and the peripheral and inside edges.

8. A fork lift attachment comprising:
a load-engaging portion; and
the clip as in claim 1.

9. The fork lift attachment as in claim 8, wherein the fork lift attachment is selected from a group consisting of a fork lift fork, a rug pole attachment, a lifting boom, a trailer spotter attachment, a sideshifter, and a fork positioner.

10. A method for indicating when a clip is sufficiently worn that it should no longer be used for mounting a fork lift attachment to a fork lift carriage, the method comprising:
providing a clip comprising a base portion and an extension portion;
wherein the base portion adjoins a load-engaging portion of the fork lift attachment or is structured and dimensioned for securing the clip to the load-engaging portion of the fork lift attachment;
wherein the extension portion is integral with the base portion but is not in direct physical contact with the load-engaging portion of the fork lift attachment even when the base portion adjoins or is secured to the load-engaging portion of the fork lift attachment;
wherein the extension portion extends beyond the base portion in a generally vertical direction, and comprises an inside wear/bearing surface that faces the load-engaging portion of the fork lift attachment across a gap that is formed between the extension portion and the load-engaging portion of the fork lift attachment when the base portion adjoins or is secured to the load-engaging portion of the fork lift attachment;
wherein the extension portion further comprises a generally horizontal peripheral wear/bearing surface at a peripheral end of the extension portion; and
wherein the clip comprises two opposing, generally vertical, side surfaces, each of the two side surfaces meeting the peripheral wear/bearing surface at a respective peripheral edge, and each of the two side surfaces meeting the inside wear/bearing surface at a respective inside edge;
including a wear indicator on at least one of the two side surfaces, the wear indicator being visually distinguishable from a remainder of the at least one side surface, the wear indicator being offset from the respective peripheral edge of the at least one side surface by a peripheral offset amount, and the wear indicator being offset from the respective inside edge of the at least one side surface by an inside offset amount;
selecting the peripheral offset amount to be an amount of wear of the peripheral wear/bearing surface beyond which the clip should no longer be used as a safety precaution; and
selecting the inside offset amount to be an amount of wear of the inside wear/bearing surface beyond which the clip should no longer be used as a safety precaution.

11. The method as in claim 10, wherein the wear indicator is composed of the same material as a remainder of the extension portion.

12. The method as in claim 10, wherein the wear indicator is composed of a different material than a remainder of the extension portion.

13. The method as in claim 10, wherein the wear indicator is embossed on the at least one side surface.

14. The method as in claim 10, wherein the wear indicator is stamped on the at least one side surface.

15. The method as in claim 10, wherein the wear indicator is painted on the at least one side surface.

16. The method as in claim 10, wherein a color of the wear indicator is different than a color of the remainder of the at least one side surface between the wear indicator and the peripheral and inside edges.

17. A clip for a fork lift attachment, the clip being used for mounting the fork lift attachment on a fork lift carriage, the clip comprising:
a base portion and an extension portion;
wherein the base portion adjoins a load-engaging portion of the fork lift attachment or is structured and dimensioned for securing the clip to the load-engaging portion of the fork lift attachment;
wherein the extension portion is integral with the base portion but is not in direct physical contact with the load-engaging portion of the fork lift attachment even when the base portion adjoins or is secured to the load-engaging portion of the fork lift attachment;
wherein the extension portion extends beyond the base portion in a generally vertical direction, and comprises an inside wear/bearing surface that faces the load-engaging portion of the fork lift attachment across a gap that is formed between the extension portion and the load-engaging portion of the fork lift attachment when the base portion adjoins or is secured to the load-engaging portion of the fork lift attachment;
wherein the extension portion further comprises a generally horizontal peripheral wear/bearing surface at a peripheral end of the extension portion;
wherein the clip comprises two opposing, generally vertical, side surfaces, each of the two side surfaces meeting the peripheral wear/bearing surface at a respective peripheral edge, and each of the two side surfaces meeting the inside wear/bearing surface at a respective inside edge; and
wherein at least one of the two side surfaces comprises a means for indicating when the clip is sufficiently worn that it should no longer be used for temporarily mounting the fork lift attachment to the fork lift carriage.
